(19) United States
(12) Patent Application Publication
(10) Pub. No.: US 2014/0077417 A1
(43) Pub. Date: Mar. 20, 2014

(54) STANDOFF GENERATING DEVICES AND PROCESSES FOR MAKING SAME

(71) Applicant: BATTELLE MEMORIAL INSTITUTE, Richland, WA (US)

(72) Inventors: Leonard S. Fifield, Kennewick, WA (US); Dean W. Matson, Kennewick, WA (US); Kevin L. Simmons, Kennewick, WA (US); Matthew P. Westman, Pasco, WA (US)

(73) Assignee: BATTELLE MEMORIAL INSTITUTE, Richland, WA (US)

(21) Appl. No.: 13/622,253

(22) Filed: Sep. 18, 2012

(51) Int. Cl. B29C 35/02; B29C 47/00; A21C 11/16

(52) U.S. Cl. 264/401; 425/376.1; 425/382 R; 425/174

(57) ABSTRACT

Standoff generating devices, arrays, and processes are disclosed for producing standoffs of various shapes, aspect ratios, and mechanical properties on a receiving surface for production of, e.g., vacuum-insulated glass units (VIGUs).

### FIELD OF THE INVENTION

The present invention relates generally to manufacture of standoffs used in vacuum-insulated glass units (VIGUs). More particularly, the present invention relates to new standoff generating devices and processes for making standoffs of various shapes and compositions.

### BACKGROUND OF THE INVENTION

Standoff devices (standoffs) provide separation between, e.g., glass panes in vacuum-insulated glass units (VIGUs) so that an evacuated (i.e., vacuum) cavity can be formed between the panes. Standoffs can be made of metals (e.g., stainless steel), glass, sapphire, and/or structural foams. Current manufacturing for VIGUs employs pick-and-place robots that place individual standoffs on the pane surfaces. However, capital costs for such robotic systems require retail sales prices for pane windows to be at least two times the manufacturing price in order to be competitive on a cost-per-basis. Simpler manufacturing systems could decrease manufacturing costs allowing manufacturers to recoup manufacturing costs while providing high-quality, but lower-cost products. The present invention addresses these needs by providing devices and processes that keep manufacturing costs low while allowing standoffs to be manufactured at a price that competes well with triple pane glazing.

### SUMMARY OF THE INVENTION

New standoff generating devices and processes are disclosed for making standoffs of various shapes and compositions suitable for use in applications including, but not limited to, e.g., fabrication of vacuum-insulated glass units (VIGUs). Processes disclosed herein permit standoffs to be formed on various receiving surfaces including glass panes without deformation of the surfaces caused by pressure differentials observed in conventional processes between the inside and outside of the VIGU.

Standoff generating devices described herein may include a dispensing element (conduit) that can include a dispensing channel in material communication with a reservoir. The reservoir may be configured to contain a shape-forming material therein. The dispensing channel may include an inlet or inlets that introduce the shape-forming material from the reservoir to the dispensing channel and a dispensing tip configured with an in-tip, shape-forming mold at the exit of the dispensing channel. The dispensing tip may dispense the shape-forming material from the dispensing channel to the receiving surface with a selected shape while the shape-forming material is in contact with the receiving surface that yields a standoff on the receiving surface with a selected or desired shape and composition that provides suitable mechanical properties to the standoffs produced thereby.

The dispensing tip may be an exchangeable dispensing tip or a replaceable dispensing tip.

The dispensing tip of the standoff generating device may include an in-tip mold that delivers a selected shape to the standoffs formed therein. Shapes can include, but are not limited to, e.g., cylindrical shapes, pyramidal shapes, square shapes, conical shapes, spherical shapes, hemispherical shapes, spheroidal shapes, pillar shapes, rectangular shapes, triangular shapes, trigonal shapes, round shapes, circular shapes, including combinations of these various shapes. Shapes may also be a complex shape. Complex shapes include, but are not limited to, e.g., star shapes, incomplete pie shapes, tapered shapes, and other shapes including combinations of simple and complex shapes.

In some applications, the standoff generating device may form standoffs on a receiving surface with aspect ratios (i.e., height to diameter) greater than about 2. In some applications, height of the standoff measured from the receiving surface may be about 500 μm and the cross-sectional diameter may be about 100 μm. In some applications, standoffs on the receiving surface may include a pillar form with an aspect ratio greater than or equal to about 3.

The standoff generating device may form standoffs on the receiving surface that include one or more physical features (e.g., extensions) on the surface of the standoffs. Physical features can be selected to increase the strength of the standoff on the receiving surface containing a lessor quantity of standoff material compared to standoffs dispensed absent the features. In some applications, the features may extend orthogonal to the plane of the receiving surface to maintain the aspect ratio of the standoff on the receiving surface. Features may include pointed protrusions positioned orthogonal to the height direction. Features may also include rounded protrusions positioned orthogonal to the height direction.

The dispensing tip may deliver a standoff to the receiving surface with a height dimension measured from the receiving surface of from about 0.01 mm to about 8 mm. In some applications, the height dimension may be from about 1 mm to about 6 mm.

The dispensing tip may be configured to deliver one or more standoffs to a receiving surface that when cured have a compressive strength of at least about 60 MPa.

Standoff generating devices described herein may further be automated to control aspect ratios or other dimensions, spacing between adjacent standoffs on a receiving surface, as well as the dispensing, curing, and delivery of the shape-forming materials (e.g., in selected patterns).

The standoff generating device may include an energy source that couples to the shape-forming (i.e., in-tip mold) portion of the standoff generating device to deliver energy of a selected type to the shape-forming material therein to at least partially cure the shape-forming material while the shape-forming material is present in the in-tip mold. The shape-forming material may be dispensed from the dispensing tip to the receiving surface in a semi-cured, or a cured state. The shape-forming material may also be dispensed to the receiving surface in an uncured (e.g., green) state and then fully cured with the energy source after being dispensed.

Energy sources include, but are not limited to, e.g., thermal or heat energy sources, acoustic energy sources (e.g., ultrasonic sources), light-emitting energy sources (e.g., ultra-violet (UV) energy sources, infra-red (IR) energy sources, visible light energy sources, etc.), microwave energy sources, radiation-generating energy sources (X-ray sources, gamma sources, etc.), including combinations of these various energy sources.

The receiving surface may be a pane surface. The pane surface may include a material selected from: metals, ceramics, glasses, polymers, composites thereof, including combinations of these various materials.

Standoffs may be formed with a single standoff generating and dispensing device or an array (e.g., two or more) of standoff generating and dispensing devices. Standoff generating devices may allow formation of different patterns or densities of standoffs on a receiving surface.

A method is also disclosed for making standoffs on a receiving surface that include a selected aspect ratio. The method may include: dispensing a shape-forming material from at least one dispensing device to a receiving surface to form at least one standoff with a selected shape on the receiving surface. The standoffs may include the selected shape and aspect ratio upon contact with the receiving surface. The process may be used to control the aspect ratio of standoffs on a receiving surface when deployed in the production, e.g., of VIGUs.

The method may further include curing the shape-forming material to form at least one standoff on a receiving surface with a selected shape and a selected aspect ratio.

The shape-forming material may be dispensed to the receiving surface in an uncured or green state, a semi-cured state, or a cured state. In some applications the shape-forming material may be at least partially cured while dispensing the shape-forming material to a receiving surface. In some embodiments, the shape-forming material may be at least partially cured after dispensing the shape-forming material to a receiving surface.

Dispensing the shape-forming material may include dispensing from a standoff generating (dispensing) device that includes a reservoir configured to contain the shape-forming material and a dispensing channel (conduit) having at least one inlet in material communication with the reservoir that introduces the shape-forming material to the dispensing channel and at least one exit that dispenses the shape-forming material to a receiving surface. The dispensing device may include a dispensing tip with an in-tip mold that shapes the shape-forming material dispensed through the dispensing tip to the receiving surface.

The shape-forming material may include various compositions that may include one or more of: polymers, resins, metals, plastics, glasses, getters (e.g., desiccants), composites thereof, including combinations of these various materials.

Getters can include, but are not limited to, e.g., moisture getters, hydrogen getters, helium getters, organic getters, activated carbon, silica, titanium, and combinations thereof.

Polymers for standoffs may include: epoxies, polyurethanes, acrylics, polyesters, including combinations of various polymers. Polymers may be selected that provide the standoffs with a sufficient compressive strength on the receiving surface. Standoffs may include one or more low out-gassing polymers such that when installed in an assembled device provides a gas release less than about 0.05 wt % of the standoff material per year therein. Standoffs may also include, or be composed of, a polymer or polymers containing a fast-reacting catalyst or a fast-acting curing agent therein that permits the standoffs to cure within a time of from milliseconds to minutes. Standoffs may also include a resin that is optically clear. In some applications, the polymer may include a heat-curable resin. In some applications, the standoffs may include a resin containing fillers. Shape-forming materials may also include solid particles as fillers. Solid particles may include a particle size in the range from about 10 nm to about 1000 nm. The solid particles may include, or may be composed of, a material selected from the group consisting of: a glass, a metal, a ceramic, a metal oxide, silica, titania, cellulose, and combinations thereof.

The shape-forming material may include a viscosity between about 100 centipoise (cP) and about 10,000 centipoise (cP).

The shape-forming material may be dispensed with one or more standoff generating devices or from an array of standoff generating devices.

The shape-forming material may be dispensed at two or more locations on a receiving surface.

The shape-forming material may be dispensed to form a selected pattern of standoffs or density of standoffs on a receiving surface.

Dispensing the shape-forming material may include dispensing at a selected spacing or a selected separation distance to form standoffs on the receiving surface that include the selected spacing between adjacent standoffs or separation.

The shape-forming material may be dispensed to a receiving surface that includes a “low-e” coating to form standoffs thereon.

The shape-forming material may be dispensed to a receiving surface that is tempered to form standoffs thereon.

The shape-forming material may be dispensed from an underside, a top side, or both an underside and top side of a receiving surface. In some applications, the shape-forming material may be dispensed from an underside of the receiving surface such that the shape-forming material is drawn down from the receiving surface to provide a high-aspect ratio standoff thereon.

The shape-forming material may also be dispensed at a temperature selected such that the shape-forming material contacting the receiving surface has a temperature lower than the shape-forming material released from the dispensing device to form a standoff with a selected shape or molded form upon contact with the receiving surface.

Dispensing the shape-forming material may include translating, displacing, orienting, or moving the receiving surface relative to at least one standoff generating and dispensing device or vice versa.

Standoffs may include a selected height measured from the receiving surface that provides a selected separation distance between at least two panes, panels, or other structures in an assembled device.

Dispensing the shape-forming material may include turning off, or turning on, one or more dispensing devices in an array of dispensing devices to form a selected density or pattern of standoffs on a receiving surface. Turning off or turning on of the one or more dispensing devices may be performed to control the dispensing of the shape-forming material to a receiving surface based on the length and width dimensions of the receiving surface. Turning off or turning on of the one or more dispensing devices may also be performed to control spacing between adjacent standoffs on a receiving surface.

Dispensing the shape-forming material may include dispensing to a receiving surface after heating the shape-forming material to a selected temperature in the in-tip mold of at least one standoff generating and dispensing device.

Dispensing the shape-forming material may include dispensing to the receiving surface at a temperature that prevents damage to the receiving surface. In some applications, dispensing the shape-forming material may include dispensing the shape-forming material to a coated or a tempered receiving surface at a temperature below 200° C. to prevent damage to the receiving surface.

Dispensing the shape-forming material may include applying a resin adhesive to an end of the shape-forming material prior to contacting the receiving surface to affix the shape-forming material that forms the standoff when placed on the receiving surface.

Devices and processes of the present invention can reduce capital costs, providing standoffs that are less expensive to produce on a per cost basis than those produced by conventional processes. Standoffs described herein thus can represent a significant cost savings that provides significant advantages to manufacturers in various manufacturing disciplines, including those that produce VIGUs.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the preferred embodiment of the invention is shown and described by way of illustration of the best mode contemplated for carrying out the invention. As will be realized, the invention is capable of modification in various respects without departing from the invention. Accordingly, the drawings and following descriptions of the embodiments of the present invention set forth hereafter should be seen as illustrative and not limiting in any way. Additional advantages and novel features of the present invention will be set forth as follows and will be readily apparent from the descriptions and demonstrations set forth herein. A more complete appreciation of the invention will be readily obtained by reference to the following description of the accompanying drawings in which like numerals in different figures represent the same structures or elements.

### BRIEF DESCRIPTION OF THE DRAWINGS

FIGS. 1a-1b show different views of a standoff generating and dispensing device, according to an embodiment of the present invention.

FIGS. 2a-2g show expanded views of a dispensing tip that includes an in-tip mold that shapes a shape-forming material dispensed from the dispensing tip, according to an embodiment of the present invention.

FIG. 3 shows exemplary shapes for standoffs formed by the standoff generating device of the present invention.

FIG. 4 shows an exemplary process for curing standoffs dispensed from the standoff generating device.

FIG. 5 shows exemplary standoff patterns and arrays that may be formed on a receiving surface in accordance with an embodiment of the present invention.

FIG. 6 shows an exemplary non-planar receiving surface upon which standoffs may be formed in concert with the present invention.

FIG. 7 is a schematic showing an exemplary process for forming devices containing standoffs generated in concert with the present invention.

### DETAILED DESCRIPTION

New standoff generating and dispensing devices and processes are disclosed for making standoffs of various shapes and varied compositions suitable for use in various applications including, but not limited to, e.g., production of vacuum-insulated glass units (VIGUs). The following description includes a best mode of at least one embodiment of the present invention. It will be clear from this description that the invention is not limited to these illustrated embodiments but also includes a variety of modifications and embodiments thereto. The invention is to cover all modifications, alternative constructions, and equivalents falling within the scope of the invention as set forth in the claims listed hereafter. Accordingly, the description of the preferred embodiments should be seen as illustrative only and not limiting.

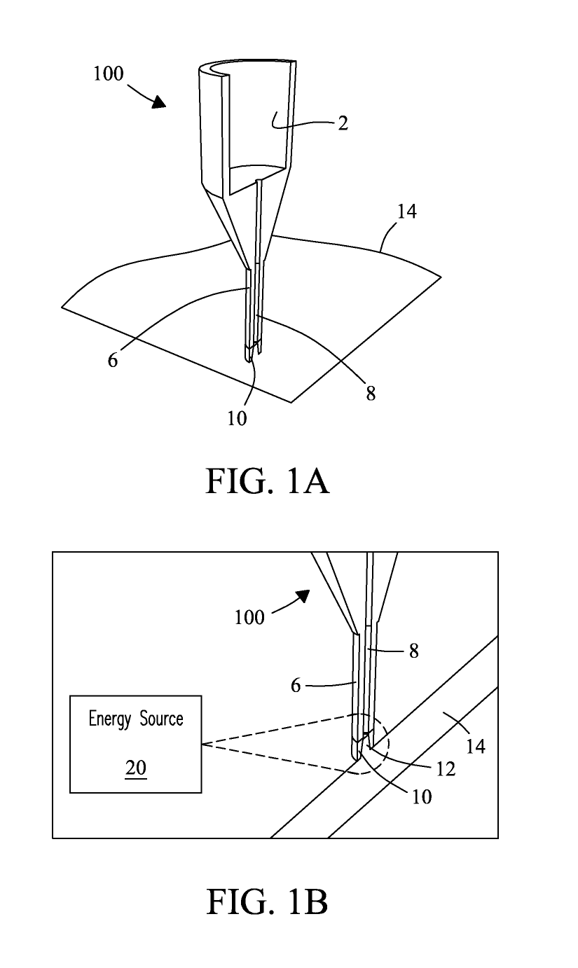

FIG. 1a shows a standoff generating and dispensing device 100 that produces one or more standoffs on a receiving surface. The term “standoff” as used herein refers to pillar or dot type structures that include an aspect ratio that provides separation between panes, panels, and non-planar structures of devices or objects during assembly of the device or object, or in the assembled or manufactured device or object for selected applications. Examples include, but are not limited to, e.g., separation of glass panes in an evacuated (i.e., vacuum) cavity of a VIGU. Standoff generating and dispensing device 100 controls the aspect ratio of the standoffs when deployed in production. The term “receiving surface” as used herein means any surface to which a standoff may be applied or delivered. Receiving surfaces include, but are not limited to, e.g., pane surfaces including coated or tempered pane surfaces, glass surfaces, metal surfaces, ceramic surfaces, composite surfaces, polymer surfaces, including non-planar surfaces having various 3-dimensional shapes and dimensions as detailed further herein. Standoff generating and dispensing device 100 may include a reservoir 2 configured to contain a shape-forming material (not shown). The term “shape-forming materials” as defined herein refers to viscous, semi-solid, molten (e.g., such as molten waxes or molten metals), or otherwise flowable liquid materials that yield shaped structures when materials delivered from device 100 are cured, cooled, and/or hardened. Reservoir 2 may link to a dispensing element 6 that defines a dispensing channel 8 into which the shape-forming material enters and through which the material flows from reservoir 2. Dispensing channel 8 may terminate in a dispensing tip 10 through which the shape-forming material exits standoff-generating and dispensing device 100 delivered to receiving surface 14.

FIG. 1b shows an expanded view of dispensing tip 10. Dispensing tip 10 may be located at a terminal or exit end of dispensing channel 8 of dispensing element 6. Dispensing tip 10 can include an in-tip mold 12 to provide a selected shape to the shape-forming material delivered through in-tip mold 12. The term “mold” as used herein means a shape-forming element, component, or portion configured to provide a selected shape to a shape-forming material or a thermoset material when introduced from reservoir 2 through dispensing tip 10. The mold can shape the various compositions of the shape-forming materials delivered through dispensing channel 8 of dispensing element 6 to form standoffs that have selected shapes and/or forms, as described herein. As shown in the figure, dispensing tip 10 may be integrated with dispensing element 6, but is not limited thereto. For example, dispensing tip 10 may be an exchangeable (replaceable) dispensing tip 10 that is a part separate from, or not integrated with, dispensing element 6. Ability to exchange dispensing tip 10 with another or different dispensing tip 10 allows generating device 100 to readily deliver standoffs of differing and various shapes to receiving surface 14, e.g., in concert with different in-tip molds 12.

Standoff generating and dispensing device 100 may further include an energy source 20 that is coupled or integrated to device 100 that delivers energy of a selected type and quantity to the shape-forming material delivered through, or dispensed from, device 100 that cures the shape-forming material yielding the standoff on the receiving surface having the selected shape, form, and desired mechanical properties for the intended application.

Two or more generating and dispensing devices 100 may be coupled and configured (e.g., in an array) to deliver a selected pattern of standoffs, a selected density of standoffs, and/or a selected distribution of standoffs to receiving surface 14. Standoffs may be of a same, a different, or various shapes, as detailed further herein.

### In-Tip Mold and Process

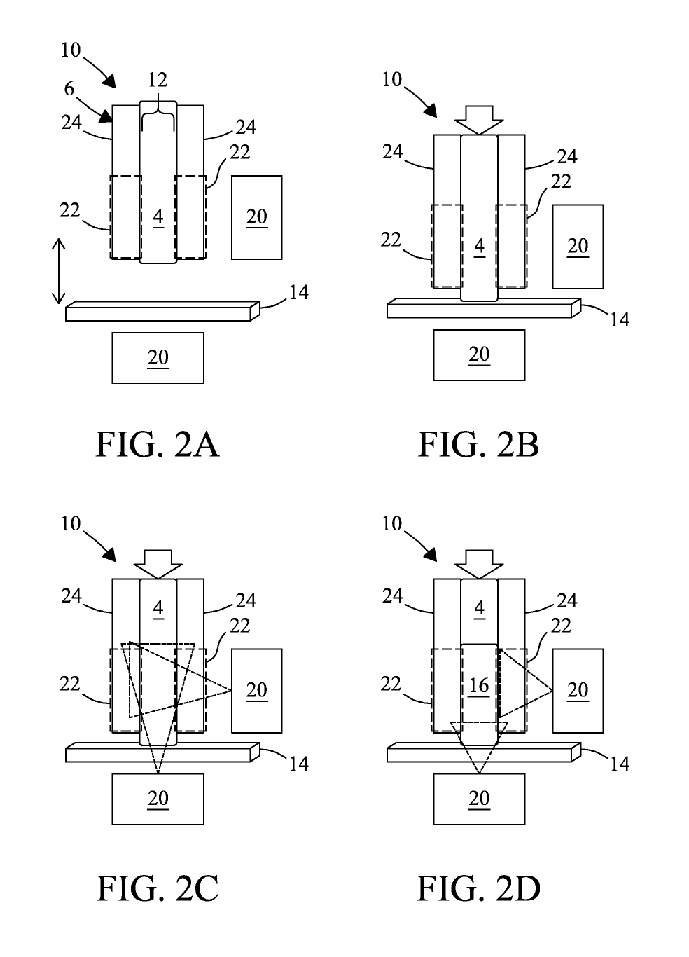

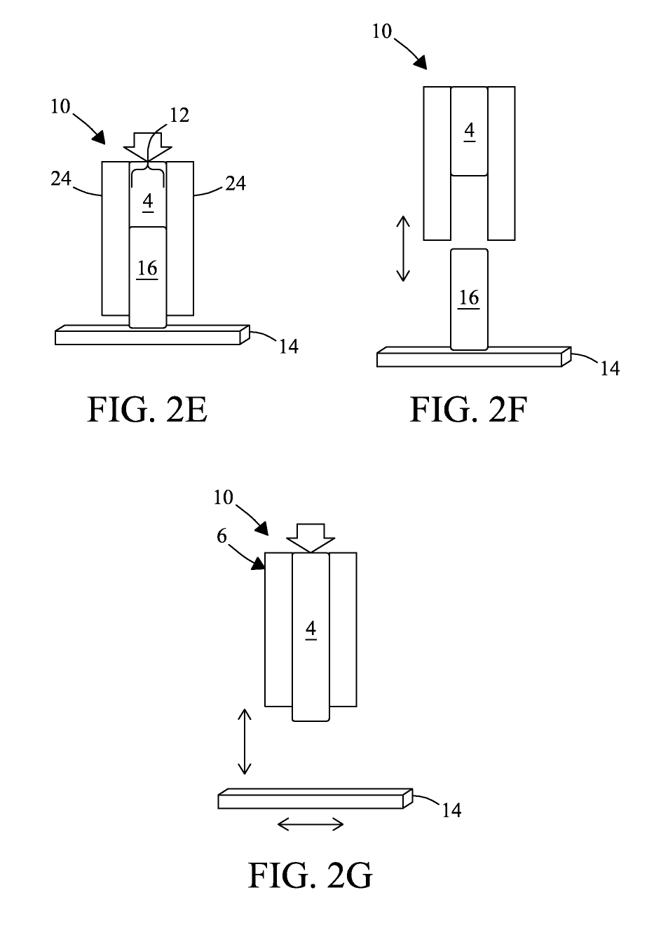

FIGS. 2a-2g illustrate an in-tip mold 12 and process for forming standoffs 16 with a selected shape on a receiving surface 14 from a shape-forming material. FIG. 2a shows an expanded view of dispensing tip 10 that includes an in-tip mold 12. Shape-forming material 4 delivered from reservoir (FIG. 1) may fill in-tip mold 12 and be partially extended from dispensing tip 10. In-tip mold 12 may be configured to deliver a selected shape to shape-forming material 4, but shapes are not limited thereto, as discussed further herein. Dispensing tip 10 may include a curing portion 22 that delivers energy of a selected type (e.g., UV, IR, acoustic, etc.) from energy source 20 to the shape-forming material delivered through in-tip mold 12 to initiate curing of shape-forming material 4 delivered to receiving surface 14. Curing portion 22 may couple to, or include, e.g., energy-emitting or energy-transmitting devices (e.g., metal conductance plates or panels), light-emitting or light-transmitting devices (e.g., light-emitting panels or windows), wavelength-emitting or wavelength-transmitting devices (e.g., optically transparent energy-emitting windows), acoustic-emitting or acoustic-transmitting devices (e.g., acoustic-emitting windows or panels), thermosetting or heat-delivery devices (e.g., infra-red devices), including combinations of these various devices. Dispensing tip 10 may also include an opaque portion 24 that blocks, does not transmit, or is otherwise opaque to energy of a selected type. For example, dispensing tip 10 may include 1) a curing portion 22 configured to transmit UV light or another energy type through curing portion 22 into shape-forming material 4 that at least partially cures shape-forming material 4, e.g., to a selected height, and 2) an opaque portion 24 that blocks transmission of UV light or another energy type into shape-forming material 4 above a certain height level. In this manner, shape-forming material 4 may be at least partially cured to a selected or designated height in dispensing tip 10 so as to yield standoffs 16 having selected heights when dispensed to receiving surface 14.

FIG. 2b shows that shape-forming material 4 may be partially extruded or dispensed through in-tip mold 12 from dispensing tip 10 to affix shape-forming material 4 to receiving surface 14.

FIG. 2c illustrates how curing of shape-forming material 4 may be initiated while shape-forming material 4 is being shaped within in-tip mold 12 in dispensing tip 10. Curing of shape-forming material 4 may be initiated by delivering energy into shape-forming material 4 with a selected energy type delivered from energy source 20. In some embodiments, curing may be performed while dispensing the shape-forming material 4 to receiving surface 14. In some embodiments, curing may be performed after dispensing shape-forming material 4 to receiving surface 14. In some embodiments, curing of shape-forming material 4 may be a partial curing. In some embodiments, curing of shape-forming material 4 may be a complete curing. In some embodiments, shape-forming material 4 may be dispensed to receiving surface 14 in an uncured (e.g., green) state before curing is initiated on receiving surface 14 to cure shape-forming material 4 thereon. As shown in the figure, orientation or location of energy source 20 is not limited. For example, energy from one or more energy sources 20 may be delivered to curing portion 22 of dispensing element 6 from one or more sides of dispensing element 6 (e.g., front, rear), from beneath receiving surface 14, from a position surrounding or circumvolving curing portion 22, or from various and multiple positions and/or orientations. And, as discussed previously above, inclusion of an opaque portion 24 can be used to block transmission of energy into shape-forming material 4 above a certain height level. In this manner, shape-forming material 4 may be at least partially cured to a selected or designated height in dispensing tip 10 so as to yield standoffs 16 having selected heights when dispensed to receiving surface 14.

In FIG. 2d, curing of shape-forming material 4 is shown proceeding at least partially from receiving surface 14 into in-tip mold 12 up through the full length of curing portion 22 of dispensing element 6, yielding a standoff 16 with a selected shape in contact with receiving surface 14. Shape-forming material 4 may be at least partially cured before, during, and/or after dispensing to receiving surface 14. No limitations are intended by the figure.

FIG. 2e shows a shaped or molded standoff 16 in contact with in-tip mold 12 of dispensing tip 10 after any selected in-tip curing. Final shape of standoff 16 in contact with receiving surface 14 may be determined by the shape and features defined by in-tip mold 12 of dispensing tip 10.

FIG. 2f illustrates release of standoff 16 from dispensing tip 10. Release of dispensing tip 10 (and in-tip mold 12) leaves standoff 16 on receiving surface 14. Orientation of release of dispensing tip 10 is not limited. For example, dispensing tip 10 may be released from the top or bottom of standoff 16.

In FIG. 2g, translation of dispensing tip 10 to another location above receiving surface 14 readies dispensing tip 10 for dispensing and curing a new portion of shape-forming material 4.

### Standoff Compositions

Compositions of shape-forming materials suitable for use in preparation of the standoffs described herein are not limited. Shape-forming materials may include, but are not limited to, e.g., glasses, metals, resins, polymers, plastics (e.g., thermoplastics), sol-gels, composites of these materials, and including combinations of these various materials. Compositions of the present invention may also include light-guiding materials such as acrylics used in visible wavelength optical fibers, or silica used in telecommunication wavelength optical fibers, or other light-enhancing materials that include or provide a selected refractive index to the shape-forming materials. No limitations are intended.

Polymers suitable for use include, but are not limited to, e.g., epoxies, polyurethanes, acrylics, and combinations thereof. In some embodiments, the standoff may include polymer that is a low out-gassing polymer with a gas release in an assembled device of less than about 0.05 wt % of the standoff per year therein.

Polymers may include resins that are optically clear. Polymers may also include heat curable or thermosetting resins or fast-acting curing agents therein that allow curing of the shape-forming materials. Preferred cure times may be from about 0.2 seconds to about 180 seconds (3 minutes), but times are not intended to be limited thereto. Polymers may also include resins containing one or more non-reactive or inactive fillers that increase the density or viscosity of the polymers, or that decrease the quantity or concentration of active components, or expensive components.

### Fillers

Fillers aide in controlling the rheology of the shape-forming materials that allow aspect ratios, heights, widths (e.g., diameter dimensions), and protrusions or extensions of the standoffs to be selected, e.g., for producing taller pillars. Fillers may include or be composed of materials including, but not limited to, e.g., selected glasses, calcium carbonate, ceramics, metals, metal oxides, silica (e.g., nanoscale silica), titania, cellulose (e.g., nanocrystalline and nanofibrillar celluloses), clay (e.g., inorganic nanoclays), carbon nanotubes, graphene (e.g., graphene nanoplatelets), activated carbon, and combinations of these various materials.

Fillers may also include or be composed of, e.g., solid particles or solid particulates of various sizes. Particle sizes may be selected from about 10 nm to about 500 μm. In some applications, nanoscale fillers may include particle sizes of from about 10 nm to about 1000 nm. In other applications, microscale filler may include particle sizes of from about 1000 nm to about 500 μm. No limitations are intended. Effective concentrations of fillers can range from about 0.1% by weight for high surface area nanoscale fillers such as nanofibrillar cellulose, to about 50% by weight for microscale fillers such as glass beads.

High surface area fillers with nanoscale dimensions (one or more dimensions˜<1 micrometer) can interact strongly with matrix resins which can dramatically influence composite viscosity and mechanical properties even at low loadings (e.g., 3% by weight or less). Nanocrystalline and nanofibrillar cellulose, inorganic nanoclays, carbon nanotubes, graphene nanoplatelets and nanoscale silica are examples of such fillers. Conventional fillers with microscale dimensions (one or more dimensions˜<1 mm) may provide similar increases in viscosity, mechanical properties and decreases in coefficient of thermal expansion at higher loadings such as 10% by weight. Fillers may continue to be proportionally advantageous at loadings up to about 50% or 60% by weight.

In one exemplary, and non-limiting, shape-forming material described herein, the shape-forming material includes a thermosetting epoxy polymer having a clay filler concentration of from about 30 wt % to about 50 wt % and a viscosity greater than about 300 cP. Incorporation of the filler into the shape-forming material increases the storage modulus of the material from about 2.6 GPa to about 3.4 GPa, or about 30%.

Properties and compositions of shape-forming materials described herein are exemplary only and are not intended to be limiting. As will be understood by those of ordinary skill in the shape-forming material arts, in some compositions and associated applications, modulus changes to standoffs will be affected by standard mixture rule conventions where, e.g., varying filler moduli, resin moduli, and matrix moduli apply. However, in other compositions and associated applications, modulus changes to standoffs will not be based on standard mixture rule conventions such as when nanoscale filler materials are employed. Thus, no limitations are intended.

### Getters

Shape-forming materials can further include a getter material as a component of the composition of the standoff. Getter materials may include moisture getter materials (e.g., desiccants); gas getters (e.g., hydrogen getters; helium getters) that absorb gases (e.g., outgases) when released in a shape-forming material or when released, e.g., in an assembled glass or vacuum unit or other assembled devices; organic getters (e.g., activated carbon); and including combinations of these various getters. No limitations are intended.

### Energy Levels for Curing Shape-Forming Materials

Energy levels delivered by the energy source 20 are not limited. For example, energy levels delivered to activate curing of the shape-forming material may be selected that optimize the properties of the standoffs deployed in an assembled device. Energy levels delivered by the energy source 20 may also be selected that minimize cure times of the shape-forming materials while minimizing thermal, photo, and/or other degradation of the shape-forming and standoff materials.

### Standoff Cure Time

Times required to cure the shape-forming material to form a standoff are not limited. In some applications, cure time may be selected from about 0.2 seconds to about 60 seconds. In some applications, cure time may be selected from about 0.2 seconds to about 80 seconds. In some applications, cure time may be selected from about 20 and 300 seconds. Preferred cure times are below about 60 seconds (1 minute).

Cure times may be managed by selecting compositions of the shape-forming material and associated curing agents that, e.g., provide time necessary to mold the shape-forming material in the standoff generating device, and to dispense the shape-forming material to a receiving surface in any of a green (non-cured), semi-cured, or cured state. The term “green” or “non-cured” as used herein means the shape-forming material has not been treated to achieve final mechanical properties. For example, the shape-forming material may be dispensed to a receiving surface with selected physical dimensions and selected shapes in a green state prior to being treated. The term “cured” as used herein means the shape-forming material has been treated to achieve desired mechanical properties (e.g., mechanical modulus) in the standoff.

### Orientation of Shape-Forming materials

Orientation at which shape-forming materials are dispensed or cured from the standoff generating devices is not limited. In some applications, shape-forming materials may be dispensed or cured from the standoff generating device from the bottom of the receiving surface downward. In some applications, shape-forming materials may be dispensed or cured from the standoff generating device from the top of the receiving surface upward. All orientations as will be selected by those of ordinary skill in the manufacturing arts are within the scope of the invention.

Processes for depositing shape-forming materials may be selected that best integrate with, or that aide assembly of end-use devices. For example, the standoff shape-forming strategy may include orienting the receiving surface such that gravity plays a role in the deposition and shaping of the shape-forming material. In some applications, the strategy may include dispensing a partially cured shape-forming material from above the receiving surface and then allowing gravity to settle and decrease the aspect ratio of the standoffs prior to the final curing. In some applications, the strategy may include dispensing a partially cured shape-forming material from below the receiving surface, where gravity drawing can lead to an increase in the aspect ratio of the standoffs prior to the final curing of the standoff on the receiving surface.

### Energy Sources

Energy sources for curing shape-forming materials are not limited. Energy sources include, but are not limited to, e.g., thermal energy sources, acoustic energy sources (e.g., ultrasonic), light energy sources (e.g., visible light sources, infra-red energy sources, ultra-violet energy sources, etc.), microwave energy sources, radiation-generating energy sources, magnetic field generating energy sources (e.g., for magnetic field induced crystallization), including combinations of these various energy sources. In some applications, the energy source may deliver energy to the shape-forming material in the in-tip mold such that the shape-forming material dispensed from the dispensing tip to the receiving surface is in a semi-cured, a semi-solid, or a cured state. In some applications, the energy source may deliver energy to the shape-forming material after the shape-forming material is dispensed or delivered to the receiving surface, which serves to cure the shape-forming material that forms the standoff on the receiving surface. In some applications, the shape-forming material may be dispensed to the receiving surface after heating the shape-forming material to a selected temperature in at least one dispensing device to at least partially cure the shape-forming material therein. In some applications, the shape-forming material.

### Properties of Shape-Forming Materials and Standoffs

Shape-forming materials may be composed of, or include, materials selected to produce standoffs that have suitable properties that ensure longevity of the standoffs when installed or introduced into the intended end device or for the intended application (e.g., as standoffs in VIGUs). Properties of shape-forming materials and standoffs include, but are not limited to, e.g., viscosity of the shape-forming materials that permits flow through the in-tip mold and dispensing tip of the generating device that yields selected shapes on the receiving surface, rheology, adhesion, porosity, coefficient of thermal expansion, compressive strength, mechanical strength modulus, and other properties as will be appreciated by those of ordinary skill in the shape-forming arts. No limitations are intended.

### Viscosity

Viscosity of the shape-forming materials may be selected to allow the shape-forming materials to flow through, and be dispensed from, the standoff generating and dispensing device, to control the rheology (e.g., flowability and shape forming properties) of the shape-forming materials, or to control mechanical properties of the shape-forming materials. Viscosities of the shape-forming materials may be selected in the range from about 100 centipoise (cP) [100 mPa·s] to about 10,000 centipoise (cP) [10,000 mPa·s]. In some applications, viscosities may be selected between about 100 cP and about 500 cP. In some applications, viscosities may be selected between about 500 cP and about 10,000 cP. No limitations are intended.

### Porosity

Porosity may be defined as the density of pores or cavities incorporated within the shape-forming material composition, and ultimately in the standoff formed on the receiving surface. Pores may include closed cell pores, open celled pores, or combinations of closed cell pores and open celled pores. Porosity may be selected to achieve selected properties in the standoffs. For example, quantity of closed cell pores or open celled pores may be used to effect visual properties as well as mechanical properties in the standoffs formed. Any degree of porosity that achieves selected properties in standoffs as will be selected by those of ordinary skill in the art in view of this disclosure are within the scope of the present invention. No limitations are intended.

### Compressive Strength

Shape-forming materials of the present invention preferably yield a compressive strength modulus to the generated standoffs that are equal to or greater than about 60 MPa, but are not intended to be limited thereto.

### Standoff Dimensions

Dimensions selected for standoffs generated in conjunction with the present invention permit specific separation distances in assembled devices (e.g., VIGUs) to be selected. No limitations are intended.

Standoffs of the present invention may include diameters greater than or equal to about 0.05 mm to about 7 mm. Diameters may also be selected from about 0.05 mm to about 0.2 mm; or from about 0.2 mm to about 0.7 mm; or from about 0.7 mm to about 7 mm.

Standoffs on the receiving surface (as measured from the receiving surface) dispensed from the standoff generating device (FIG. 1) may include a height dimension (e.g., measured from the receiving surface) of from about 0.01 mm to about 8 mm. In some applications, the height dimension may be from about 1 mm to about 6 mm; or greater than about 6 mm. In some applications, height of the standoff measured from the receiving surface may be about 500 μm and the cross-sectional diameter may be about 100 μm.

### Aspect Ratios

Standoffs of the present invention may include aspect ratios (height to width or diameter dimension) of up to about 120. Standoffs may also include aspect ratios greater than about 0.5. In some embodiments, standoffs on the receiving surface may be of a pillar form and may include an aspect ratio greater than or equal to about 3.

### Physical Features

Standoffs described herein may include various physical features (e.g., extensions) that improve, increase, or enhance desired physical and mechanical properties of the standoffs formed. Physical features can include, but are not limited to, e.g., reinforcing members such as struts, projections, points, and/or other extensions that extend from the standoff (e.g., orthogonal to the receiving surface) that ensure the mechanical integrity or that minimize the required quantity of shape-forming material in the standoff. For example, standoffs with physical features may include a lessor quantity of the shape-forming material composition but have an equivalent strength to those prepared with a greater quantity of the standoff material dispensed absent the features. In some applications, the features may extend orthogonal to the plane of the receiving surface to maintain the aspect ratio of the standoff on the receiving surface. Physical features and shapes in the standoff may be defined by the in-tip mold (die) 12 of dispensing tip 10.

### Standoff Shapes

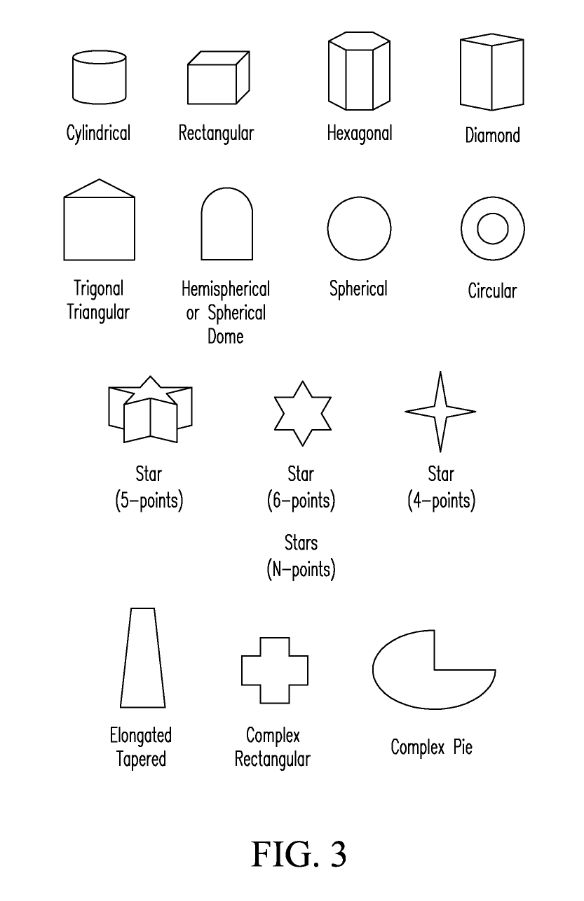

FIG. 3 shows standoffs of various shapes that can be formed by the selection of the in-tip mold (FIG. 2) used in concert with standoff generating and dispensing device (FIG. 1). The in-tip mold of dispensing tip (FIG. 2) delivers a shape-forming material or a standoff to a receiving surface that includes a selected or defined shape. Standoffs produced in conjunction with the present invention can include any shape. Standoffs may include simple shapes or complex shapes. “Simple shape” as defined herein means shapes with fixed dimensions along the length and/or diameter of the standoff. “Complex shape” as defined herein means shapes that include two or more simple shapes, or shapes that have other than fixed dimensions along the length and/or diameter of the standoff (e.g., star shapes or incomplete pie shapes). Simple shapes can include, but are not limited to, e.g., cylindrical shapes, pyramidal shapes, square shapes, conical shapes, spherical shapes, hemispherical shapes, spheroidal shapes, rectangular shapes, heptagonal, trigonal shapes, triangular shapes, octahedral shapes, round shapes, circular shapes, including combinations of these various shapes, and other shapes. Complex shapes can include, but are not limited to, e.g., star shapes including 2 or more projections or points (e.g., 3-pointed starts, 4-pointed stars, 5-pointed stars, and etc.); tapered shapes (e.g., variations in shape proceeding from the base of the standoff to the top of the standoff or vice versa (e.g., a small apex with a larger base); complex pie shapes (e.g., incomplete ovals with single or multiple missing pie sections; diamond shapes; and other complex shapes). All shapes as will be selected for standoffs that are formed in view of the disclosure herein are within the scope of the invention. No limitations are intended.

### Receiving Surfaces

Receiving surfaces may be composed of, or include, e.g., glasses; metals (e.g., stainless steel, metal alloys); polymers, plastics, thermoplastics, resins, composites thereof, coatings (e.g., low-e coatings), including combinations of these various materials. The receiving surface may include a planar (flat) surface (e.g., a pane surface); a non-planar surface (e.g., a bottle shape or a dome shape); a tempered surface (e.g., tempered glass surface), or combinations of both planar and non-planar surfaces. Pane materials may include, but are not limited to, glass pane materials, thermal pane materials, thermoplastic pane materials, tempered glass pane materials, resin pane materials, polymer composite materials, and combinations of these various pane materials. No limitations are intended.

### Array Device

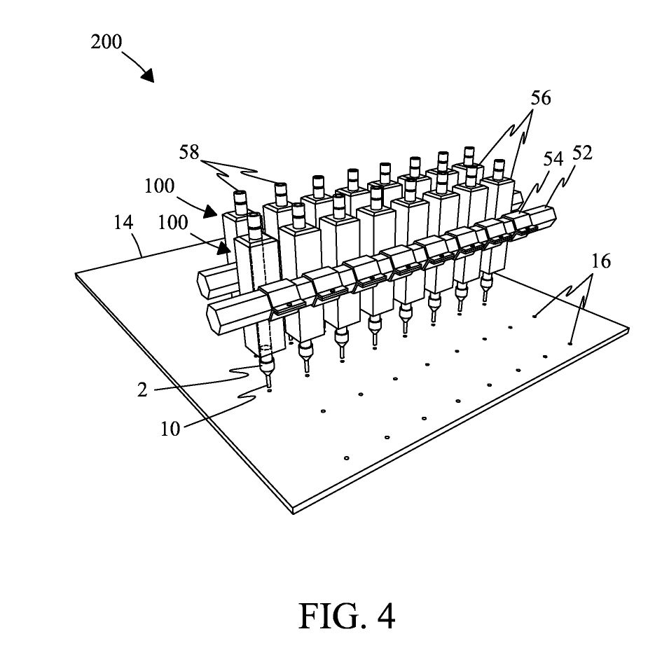

FIG. 4 shows an array device 200 according to another embodiment of the present invention that may be used to generate various standoff patterns, standoff dimensional arrays, and other patterns described herein. Array device 200 may be configured with two or more standoff generating devices 100 to generate a density of standoffs on a receiving (e.g., pane) surface 14. Standoff generating devices 100 may be mounted to bars 52 or other mounting means in concert with mounting brackets 54 or another attachment means 54. Bars 52 provide for movement, rastering, translation, and/or displacement, of standoff generating devices 100 in the array 200 along any of three selected axes [e.g., in a left/right (X-axis) direction, up/down in-plane (Y-axis), and up/down out-of-plane (Z-axis)] in combination relative to receiving surface 14 that allows selected patterns of standoffs 16 to be generated on receiving surface 14. Standoff generating devices 100 may further include a hose bib 58 that delivers shape-forming material (FIG. 2) from a supply source (e.g., a supply hose) (not shown) through a mounting body 56 to reservoir 2. Shape-forming material may then be dispensed through dispensing tip 10 to receiving surface 14. Standoff generating devices 100 of array 200 may be individually addressable such that they may be individually turned on or off to dispense shape-forming material that forms desired patterns of standoffs 16 at selected densities, with a selected spacing between adjacent standoffs, selected dimensions (e.g., height), and/or selected aspect ratios (e.g., height to width) on receiving surface 14 as described further herein.

### Standoff Patterns and Standoff Dimensional Arrays

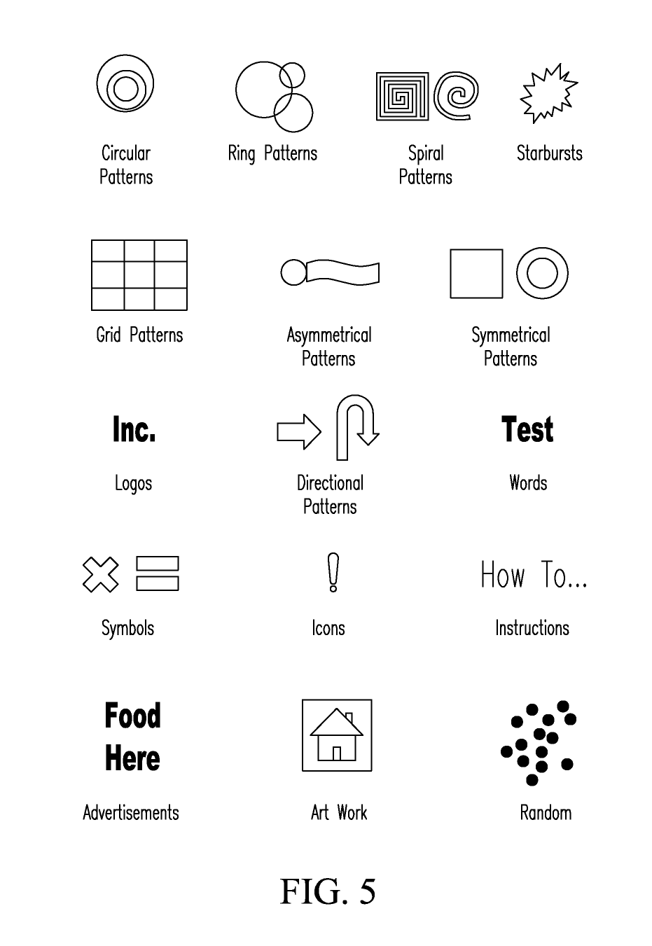

Standoffs delivered to a receiving surface may include various standoff patterns and standoff dimensional arrays. FIG. 5 shows exemplary patterns that may be produced in concert with array described previously in reference to FIG. 4. Standoff patterns may include, but are not limited to, e.g., circular patterns; rings patterns (e.g., rings within a ring); spiral patterns, starburst patterns, grid patterns, asymmetrical patterns, symmetrical patterns, directional patterns, and combinations of these various patterns. Standoff patterns may also include logos, words, symbols, icons, instructions, advertisements, artwork, and like patterns, including, combinations of these various pattern types. Patterns may also include standoff dimensional arrays such as (N×N) standoff arrays, where N is a number greater than or equal to 2, including arrays with standoffs of various heights and physical dimensions. No limitations are intended.

### Pattern Control

Dispensing the shape-forming material may include turning off or turning on one or more of the standoff generating devices dispensing devices in an array of same. In some embodiments, turning off or turning on selected devices may be performed to control the length and/or the width dimensions of the shape-forming material dispensed to the receiving surface. In some embodiments, turning off or turning on selected devices may be performed to control the spacing or density between adjacent standoffs dispensed on the receiving surface. In some embodiments, turning off or turning on selected devices may be performed to form selected patterns on the receiving surface described previously herein.

### Displacement Control

In some embodiments, dispensing the shape-forming material may include moving, rastering, displacing, or translating the receiving surface in conjunction with the dispensing device to control location or placement of standoffs on a receiving surface. For example, standoffs may be applied such that patterns or arrays of standoffs on the receiving surface can form 2-dimensional or 3-dimensional patterns and arrays, e.g., by overlapping patterns with standoffs of varying height, or diameters, or shapes.

### Multipass Control

In some embodiments, dispensing the shape-forming material may include turning off or turning on one or more of the dispensing devices to control what pattern or linear array of standoffs are formed on the receiving surface. For example, the formation of a pattern may include dispensing a first array of standoffs to the receiving surface and then dispensing a 2^{nd} or later array of standoffs to the receiving surface to complete a selected pattern or patterns on the receiving surface.

### Spacing or Density Control

Dispensing the shape-forming material may include dispensing so as to achieve a selected spacing or separation distance between adjacent standoffs on the receiving surface (e.g., more or less), a selected density (e.g., greater or lower), heights (e.g., higher or lower), diameters (e.g., wider or narrower), or dimensions of the standoffs on the receiving surface. Spacing between adjacent standoffs is not limited. Density of standoffs on a receiving surface is not limited.

### Orientation Control

Dispensing the shape-forming material may include orienting the position of the receiving surface relative to the standoff generating device or array to control the aspect ratio of the standoffs formed from the shape-forming material. For example, in some applications, shape-forming material may be dispensed to the receiving surface from beneath the receiving surface to draw the shape-forming material downward as the shape-forming material cures. In some applications, shape-forming material may be dispensed to one or more sides of the receiving surface at a time or simultaneously to form complex standoff patterns or structures on the receiving surfaces. Orientation of receiving surfaces is not limited.

### Timing Control

In some embodiments, dispensing the shape-forming material may include controlling the timing of the dispensing devices that dispense [on] and those that do not dispense [off] to the receiving surface.

### Non-Planar Receiving Surfaces

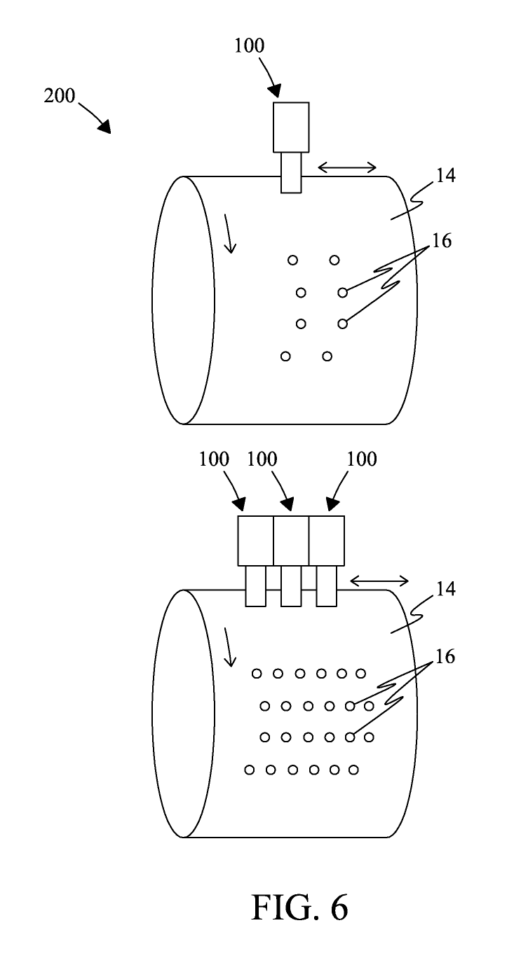

FIG. 6 shows that the shape-forming material may be dispensed to receiving surfaces 14 that are other than flat (e.g., cylindrical) to generate standoffs 16 thereon. The shape-forming material may be dispensed to the receiving surface 14 from a single standoff-generating device 100 or an array 200 of standoff-generating devices to generate standoffs 16 thereon. Standoffs 16 may be dispensed and applied to one or more sides of a receiving surface 14. Examples may include applying patterns or arrays, e.g., on an exterior surface and/or an interior surface of a contoured or non-planar surface (e.g., a cylinder or a contoured panel). All surfaces and dimensions as will be contemplated by those of ordinary skill in the art in view of this disclosure are within the scope of the invention. No limitations are intended.

### Process for Production of Devices

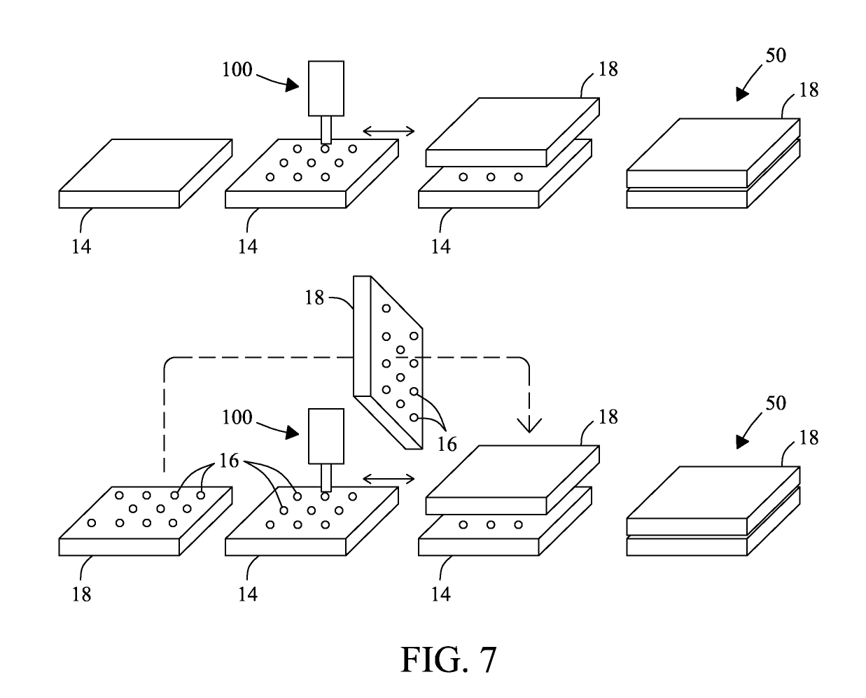

FIG. 7 is a schematic showing an exemplary process for placement of standoffs 16 on a receiving surface 14 generated in concert with the present invention, e.g., for production of an assembled device 50 (e.g., VIGUs), according to another embodiment of the present invention. In the figure, standoffs 16 may be delivered to a receiving surface 14 with one or more standoff generating devices 100 or an array of standoff generating devices (FIG. 4) to form a selected pattern on receiving surface 14. With standoffs 16 in place on receiving surface 14, a second pane, panel, or surface 18 may be placed in proper position relative to receiving surface 14 to produce assembled device 50, as will be understood by those of ordinary skill in the manufacturing arts. For example, receiving surface 14 may be moved or translated as described herein in a selected X, Y, or other dimension (e.g., up or down), or otherwise oriented relative to a second pane, panel, or surface 18 as illustrated herein (see FIG. 7) to produce assembled devices 50. Standoff generating devices 100 or an array of standoff generating devices (FIG. 4) may be used to generate patterns and arrays. All devices that will be assembled in concert with standoffs generated in concert with the present invention are within the scope of the present invention. No limitations are intended.

### Applications

Standoffs made in conjunction with the present invention may be installed or employed in the manufacture of various devices or applications including, but not limited to, VIGUs, evacuated devices, cryogenic vessels and devices; insulation panels and insulation devices, e.g., for insulating applications, display cases, protective enclosures, and like devices. All devices as will be constructed with standoffs generated as detailed herein are within the scope of the present invention. No limitations are intended.

The following Examples provide a further understanding of the present invention.

### Example 1

### Standoff Generation without Fillers with Thermal Cure

A shape-forming material mixture was prepared without fillers by thoroughly stirring 10 g of EPO-TEK® 377 Part A epoxidized diol (Epoxy Technology, Inc., Billerica, Mass., USA) and 10 g of EPO-TEK® 377 Part B anhydride (Epoxy Technology, Inc., Billerica, Mass., USA) to produce a mixture with a viscosity between about 100 centipoise (cP) and 300 centipoise (cP). The viscous mixture was loaded into the reservoir 2 of standoff generating device 100. A glass pane surface 14 with dimensions 6 inches (15 cm) by 6 inches (15 cm) was positioned below the dispensing device 100 and the dispensing tip 10 was subsequently brought in contact with the pane 14. The shape-forming epoxy mixture was dispensed from the dispensing tip 10 with a pulse of pneumatic pressure. A 3 inch (7.5 cm) by 3 inch (7.5 cm) grid of standoffs 16 composed of the shape-forming material was dispensed onto the receiving surface 14 with a spacing of 5 mm between individual standoffs 16. The receiving surface 14 was heated by contact with a hot plate from below the surface to pre-cure the shape-forming material thermally. The shape-forming material was later fully cured with subsequent heating.

### Example 2

### Standoff Generation with Fillers with Thermal Cure

A shape-forming material mixture was prepared containing fillers to provide a selective thermal cure and a standoff with suitable mechanical properties by thoroughly stirring 10 g of EPO-TEK® 377 Part A epoxidized diol (Epoxy Technology, Inc., Billerica, Mass., USA), 10 g of EPO-TEK® 377 Part B anhydride (Epoxy Technology, Inc., Billerica, Mass., USA), and 0.5 g Nanomer® I.28E modified montmorillonite nanoclay (filler) (Nanocor, Inc., Hoffman Estates, Ill., USA) to produce a mixture with a viscosity greater than 300 cP. The viscous mixture was loaded into the reservoir 2 of standoff generating device 100. A glass pane surface 14 with dimensions 6 inches (15 cm) by 6 inches (15 cm) was positioned below the dispensing device 100 and the dispensing tip 10 was subsequently brought in contact with the pane surface 14. The shape-forming epoxy mixture was dispensed from the dispensing tip 10 with a pulse of pneumatic pressure. A 3 inch (7.5 cm) by 3 inch (7.5 cm) grid of standoffs 16 composed of the shape-forming material was dispensed onto the receiving surface 14 with a spacing of 5 mm between individual standoffs 16. The receiving surface 14 was heated by contact with a hot plate from below the surface to pre-cure the shape-forming material thermally. The shape-forming material was later fully cured with subsequent heating.

### Example 3

### Standoff Generation without Fillers with UV Cure

A shape-forming material mixture was prepared without fillers to provide a selective photo cure to produce standoffs with suitable mechanical properties. DYMAX® UltraLight-Weld® OP-4-20632 polyester acrylate (Dymax Corp., Torrington, Conn., USA) was loaded into the reservoir 2 of standoff generating device 100. A glass pane surface 14 with dimensions 6 inches (15 cm) by 6 inches (15 cm) was positioned below the dispensing device 100 and the dispensing tip 10 was subsequently brought in contact with the pane surface 14. The shape-forming epoxy mixture was dispensed from the dispensing tip 10 with a pulse of pneumatic pressure. A 3 inch (7.5 cm) by 3 inch (7.5 cm) grid of standoffs 16 composed of the shape-forming material was dispensed onto the receiving surface 14 with a spacing of 5 mm between individual standoffs 16. A UV source 20 positioned below the transparent receiving surface 14 was employed to pre-cure the shape-forming material. The shape-forming material was later fully cured with subsequent UV exposure from above the receiving surface 14.

While exemplary embodiments of the present invention have been shown and described, it will be apparent to those skilled in the art that many changes and modifications may be made without departing from the invention in its true scope and broader aspects. The appended claims are therefore intended to cover all such changes and modifications as fall within the spirit and scope of the invention.

What is claimed is:

1. A standoff generating device, comprising:
a dispensing element defining a dispensing channel that is in material communication with a reservoir configured to contain a shape-forming material therein, the dispensing channel is configured to introduce the shape-forming material into a dispensing tip that includes an in-tip, shape-forming mold configured to dispense the shape-forming material with a selected shape and aspect ratio to a receiving surface that yields a standoff thereon with the selected shape and aspect ratio.

2. The standoff generating device of claim 1, wherein the dispensing tip is a replaceable or an exchangeable tip.

3. The standoff generating device of claim 1, wherein the dispensing tip is configured to dispense the shape-forming material through the in-tip mold while the shape-forming material is in contact with the receiving surface.

4. The standoff generating device of claim 1, further including an energy source operatively coupled that delivers energy of a selected type to the shape-forming material dispensed by the generating device.

5. The standoff generating device of claim 4, wherein the energy source delivers the energy to the shape-forming material after the shape-forming material is delivered from the dispensing tip to the receiving surface in an uncured state.

6. The standoff generating device of claim 4, wherein the energy source delivers the energy to the shape-forming material in the dispensing tip to at least partially cure same therein prior to delivery from the dispensing tip to the receiving surface.

7. An array device comprising two or more standoff generating devices of claim 1.

8. The array of claim 7, wherein the standoff generating devices are configured to deliver a selected pattern of standoffs to a receiving surface with a selected density and/or a selected separation distance between adjacent standoffs thereon.

9. A standoff generating method, comprising the steps of:
dispensing a shape-forming material from at least one standoff generating device to a receiving surface; and
curing the shape-forming material to form at least one standoff or a pattern of standoffs on the receiving surface having selected shapes and aspect ratios.

10. The method of claim 9, wherein the dispensing is performed while the shape-forming material is in contact with the receiving surface.

11. The method of claim 9, wherein dispensing the shape-forming material includes dispensing at two or more locations on the receiving surface.

12. The method of claim 9, wherein the dispensing includes dispensing the shape-forming material from an array of dispensing devices to form a plurality of standoffs, an array of standoffs, and/or a selected pattern of standoffs on the receiving surface.

13. The method of claim 9, wherein the dispensing includes dispensing the shape-forming material to the receiving surface in a non-cured, semi-cured, or cured state.

14. The method of claim 9, wherein the curing includes curing the shape-forming material while dispensing the shape-forming material to the receiving surface.

15. The method of claim 9, wherein the curing includes curing after dispensing the shape-forming material to the receiving surface.

16. The method of claim 9, wherein the curing includes curing the shape-forming material with energy of a selected type delivered from an energy source.

17. The method of claim 9, wherein the dispensing includes dispensing the shape-forming material through a mold disposed within the at least one generating device to shape the shape-forming material delivered to the receiving surface.

18. The method of claim 9, wherein the dispensing includes dispensing the shape-forming material from an underside, a top side, or both the underside and top side of the receiving surface.

19. The method of claim 9, wherein the dispensing includes dispensing the shape-forming material to the receiving surface at a temperature that is greater or lower than the temperature of the shape-forming material dispensed from the standoff generating device.

20. The method of claim 9, wherein the dispensing includes translating, displacing, orienting, and/or moving the receiving surface relative to the at least one dispensing device or vice versa.

21. The method of claim 9, wherein the dispensing includes turning off, or turning on, one or more standoff generating devices in an array of same to form a pattern of standoffs on the receiving surface.

22. The method of claim 9, wherein the pattern on the receiving surface includes a selected density or a selected spacing between adjacent standoffs on the receiving surface.
